(19) United States
(12) Patent Application Publication
(10) Pub. No.: US 2002/0016776 A1
(43) Pub. Date: Feb. 7, 2002

(54) Distributing digital content

(76) Inventors: Chorng-Yeong Chu, San Jose, CA (US); Fred S. L. Chan, Cupertino, CA (US); Edward Y.C. Chan, Cupertino, CA (US)

Correspondence Address: David R. Stevens, Stevens & Westberg, LLP, Suite 201, 99 North First Street, San Jose, CA, 95113, US

(21) Appl. No.: 09/905,608

(22) Filed: Jul. 13, 2001

Related U.S. Application Data
(63) Continuation of application No. 09/534,698, filed on Mar. 24, 2000.

(30) Foreign Application Priority Data
Mar. 23, 2001 (US) PCT/US01/09449
Mar. 16, 2001 (TW) 90106151

(51) Int. Cl. G06F 17/60

(52) U.S. Cl. 705/52

(57) ABSTRACT

The method and apparatus for distributing digital content includes a local storage medium, a local digital content reader, a remote digital content enabler, and a transmission medium. The local digital content reader transmits a request signal through the transmission medium to the remote digital content enabler requesting an enabler signal to unlock the digital content stored on the local storage medium. The remote digital content enabler processes the request signal and then transmits the enabler signal back to the local digital content reader. The enabler signal enables the local digital content reader to read at least one of the digital contents stored on the local storage medium.

### BACKGROUND

The present invention relates generally to distribution of digital content.

A number of technologies have been developed for electronic commerce transactions (E-commerce) and for distributing digital content. One of the most common tools employs a personal computer connected to the Internet through a browser to an Internet Service Provider (ISP), allowing a user to browse for information, view or post advertisements, download and disseminate digital information, or buy and sell items over the Internet. The speed at which Internet transactions take place depends on the speed of the personal computer's processor, the speed of the ISP server's processor, and the type of Internet connection (ISDN line, direct connection, cable modem, or standard telephone modem) between the personal computer and ISP server.

Convergent television and computer technologies, such as Microsoft TV (or WebTV), provide another E-commerce and digital distribution technology. Microsoft TV combines television and the Internet, using a set-top box connected to both a telephone line and a cable TV line along with one or more input devices such as a keyboard or mouse. A Microsoft TV-enabled set-top box provides the ability to merge standard broadcast programs with the Internet as well as provide interactive program guides and targeted digital advertiser information through the Vertical Blanking Intervals (VBI) of a TV broadcast. A remote control or other input device can operate the Microsoft TV-enabled set-top box so a user can search and receive advertised digital information and purchase items on the television and through the Internet.

Another interactive television system, developed by Wink Communications (Wink), provides a service which allows a user to interact with television shows and advertisements while watching television. First, a television broadcaster or advertiser can use Wink software to create enhanced television applications. These applications can be, for example, additional digital information about a television program, or advertising and purchasing information related to a television program or advertisement. A Wink Broadcast Server then manages the scheduling and insertion of the enhanced television applications into targeted television programming using VBI or other techniques.

At the local television receiver, an appropriate set-top box decodes the received enhanced television application and allows the television user to access the enhanced application. When a consumer responds to a Wink enhancement and requests information or orders a product, Wink software in the set-top box or television generates a response packet. A Wink response server collects these viewer response packets from television and satellite set-top boxes using a telephone dialup, or from cable set-top boxes through cable head-end systems. The response packets are collected, aggregated, converted into electronic orders (including, e.g., name, address, and credit card information if appropriate), and sent on to the advertiser or network for fulfillment.

Video CD Internet is another technology which provides consumer access to digital content. Video CD Internet uses simple text files to define a relation between the contents on a video CD disk and a URL address. Therefore, information on the video CD disk can provide a unidirectional link to a particular URL address on the world wide web.

Digital Video Express (Divx) is another technology developed to provide consumer access to digital content. Divx is a special Digital Video Disk (DVD-ROM) format, in which the Divx disks include one or more encrypted movies. The Divx disks require a special DVD player having a Divx enhancement. To watch a Divx movie, a user plays the disk in a Divx player, opens an account with Divx, and provide a valid credit card. Each Divx movie can only be viewed for a limited period, beginning when the Divx disk is first inserted into the Divx player. Additional viewing periods can be purchased electronically, and all charges are recorded by the Divx player and telephoned in to a central server in the Divx billing office via a modem in the player to exchange billing information. The Divx format, though, did not receive widespread consumer acceptance and has been discontinued.

### SUMMARY

In general, in a first aspect, the invention features a system for distributing digital content including a local digital content reader, a local storage medium, a remote digital content enabler, and a transmission medium. The local digital content reader transmits a request signal to the remote digital content enabler requesting an enabler signal to unlock the digital content stored on the local storage medium. The remote digital content enabler processes the request signal and then transmits the enabler signal back to the local digital content reader. The enabler signal enables the local digital content reader to read at least one of the digital contents stored on the local storage medium.

Embodiments of the invention may include one or more of the following. The remote server can store digital content. The digital content stored on the local storage medium and the remote server can be displayed on a local display. The local storage medium can include at least one file for protecting the contents of the local storage medium and multiple content directories. The content directories can have at least two files which contain separate digital content configured under different digital formats respectively. The content directories can include any of video, audio, photographic, or hypertext content. The video content can be encoded in any of MPEG1, MPEG2, MPEG4, or Digital Video formats. The audio content can be encoded in any of MPEG Layer 2, MPEG Layer 3, AC3, DTS, DVD audio, or AAC formats. The photographic content can be encoded in any of JPEG, GIF, or PNG formats. The hypertext content can be any of text, HTML, or Javascript formats. The digital content on the local storage medium can be encrypted. The local digital content reader can decrypt the encrypted digital content stored on the local storage medium upon receipt of the enabler signal. The digital content on the local storage medium can contain payment information. The request signal can contain information requesting specific digital content. The payment information can comprise any of a credit card number, debit card number, or a pre-paid debit card number. The payment information can comprise accumulated credit. The accumulated credit can be purchased with any of a credit card number, debit card number, or pre-paid debit card number. The accumulated credit can be accumulated without requiring payment.

In general, in another aspect, the invention features a method for distributing digital content, the method including the steps of: storing at least two separate digital contents on a local storage medium, transmitting a request signal from a local digital content reader to a remote digital content enabler over a transmission medium to request access to at least one of the digital contents, receiving an enabler signal at the local digital content reader from the remote digital content enabler over the transmission medium to enable the local digital content reader to access at least one of the digital contents stored on the local storage medium, and reading at least one of the digital contents stored on the local storage medium.

In general, in another aspect, the invention features a system for displaying digital content from a remote server and a local storage medium including a local storage medium, a local digital content reader, a remote server, a transmission medium, an input device, and a local display. The local storage medium stores a first portion of the digital content. The local digital content reader reads the first portion of the digital content stored on the local storage medium and transmits a request signal from the local digital content reader to the remote server through the transmission medium requesting access to a second portion of the digital content. The remote server stores digital content and enables access to the first portion of the digital content stored on the local storage medium. The remote server also transmits an enabler signal from the remote server, through the transmission medium, to the local digital content reader to enable the first portion of the digital content stored on the local storage medium. Furthermore, the remote server transmits the second portion of the digital content to the local digital content reader. The input device is used to input data to the local digital content reader. The local display displays both the first and second portions of the digital content.

Embodiments of the invention may include one or more of the following. The local digital content reader including a communication device for accessing the instant digital content stored in the remote server through the transmission medium, a random access memory, a read only memory, at least one input or output port, a power supply and the local storage medium for storing local digital content. The input or output port can be an RJ11 connector, an AV connector, a S/PDIF connector, and/or a S-Video connector. The local digital content reader can be a host 15 computer, the host computer comprising a central processor unit, a non-volatile storage, a communication device for accessing the digital content stored in the remote server through the transmission medium, and the local storage medium for storing local digital content.

In general, in another aspect, the invention features a method for displaying digital content from a remote server and a local storage medium, the method comprising the steps of: storing a first portion of the digital content on a local storage medium, storing a second portion of the digital content on a remote server, transmitting a request signal from a local digital content reader to the remote server over a transmission medium, receiving an enabler signal and the second portion of the digital content at the local digital content reader from the remote server over the transmission medium, using the enabler signal to access the first portion of the digital content stored on the local storage medium, uploading the first and second portion of the digital content from the local digital content reader to a local display, and displaying the first and second portion of the digital content on the display.

In general, in another aspect, the invention features a local digital content reader including a local storage medium, a communication device, and a central processing unit. The local storage medium stores a first portion of a digital content. The communication device transmits a request signal from the local digital content reader to a remote server over a transmission medium and receives an enabler signal and second portion of the digital content from the remote server. The central processing unit receives the enabler signal and, upon receipt, accesses the first portion of the digital content stored on the local storage medium and then uploads the first and second portions of the digital content to a local display.

In general, in another aspect, the invention features a remote server including a remote storage medium, a communication device, and a central processing unit. The remote storage medium stores digital content. The communication device receives a request signal from a local digital content reader over a transmission medium, transmits an enabler signal to a local digital content reader over the transmission medium to access a first portion of the digital content stored on a local storage medium, and transmits a second portion of the local digital content stored on the remote storage medium to the local digital content reader over the transmission medium. The central processing unit accesses the second portion of digital content from the remote storage medium.

Embodiments of the invention may provide one or more of the following advantages. Internet digital content can be cost effectively uploaded from a local storage medium to a local display screen, saving both internet bandwidth and download time. Also, internet digital content can be distributed to a user in a more cost effective way than through a VBI analog television signal. Multiple formats of digital content can be distributed on a single storage medium. Sections of digital content stored on a disk can be unlocked while other sections of digital content on the disk remain securely locked for protection. Digital content stored on a disk can be secured and then distributed on demand. Advertising can be pulled from a local disk via a remotely downloaded internet link. In addition, internet advertising can be interactively and locally tailored based on what a user is viewing or has viewed.

### DRAWINGS

FIG. 1 shows a system for distributing digital content.

FIG. 2 shows a flow chart depicting a method for distributing digital content.

FIG. 3 shows an example of how digital content is stored on a local storage medium.

FIG. 4 shows a flow chart depicting a method for storing digital content on a local storage medium.

FIG. 5 shows a system for simultaneously displaying internet digital content from a remote server and a local storage medium on a local display.

FIG. 6 shows a local digital content reader.

FIG. 7 shows a system for simultaneously displaying internet digital content from a remote server and a local storage medium on a local display.

FIG. 8 shows a flow chart depicting a method for displaying internet digital content from a remote server and a local storage medium on a local display.

FIG. 9 illustrates different types of links which may be achievable with a system for merging local and digital content.

### DESCRIPTION

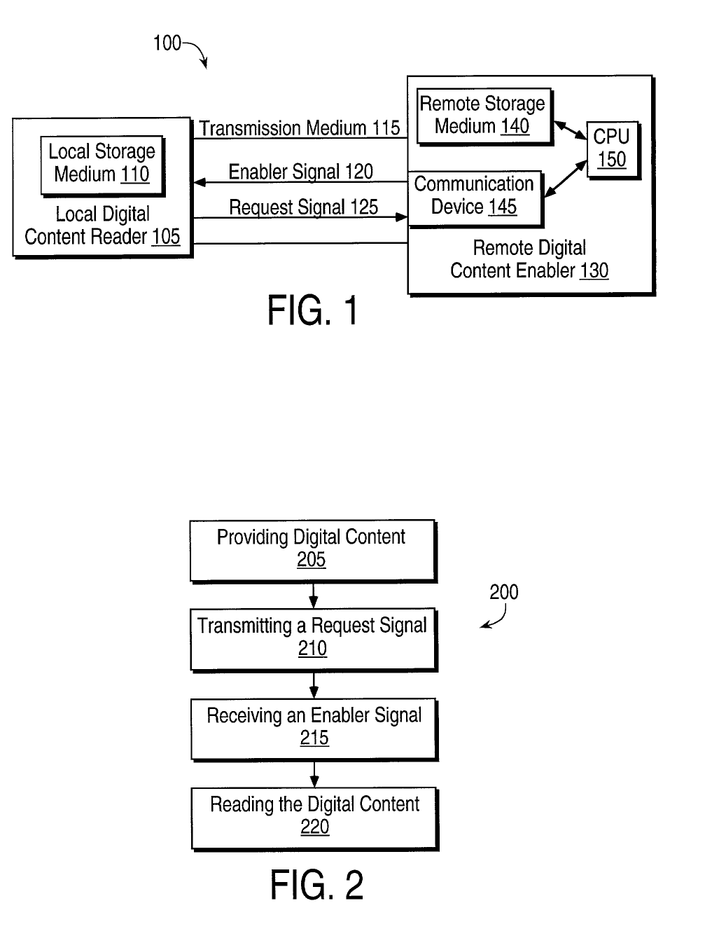

FIG. 1 shows one example of a system for distributing digital content 100, including a local digital content reader 105, a local storage medium 110, a transmission medium 115, and a remote digital content enabler 130. The remote digital content enabler includes a central processing unit (CPU) 150 electrically connected to a remote storage medium 140, and a communication device 145. The local storage medium 110 is electrically connected to the local digital content reader 105. The transmission medium 115 electrically connects the local digital content reader 105 to the remote digital content enabler 130. The transmission medium 115 can be a telephone line, wireless communication device, or a common network interface. The network interface can be any one of a number of network systems including a telephone system, a cellular network system, a local area network (LAN) system, a cable system or the Internet for exchanging and transferring information.

The local storage medium 110 can be, for example, an optically-encoded disk storing the digital content. The optically encoded-disk can be, for example, a CD or a DVD disk. In one embodiment, the digital content is stored and encrypted on the local storage medium 110 in a single digital format and divided into one or more separate chapters or titles. In another embodiment the digital content is stored and encrypted on the local storage medium 110 in multiple digital formats and divided into one or more separate chapters or titles within each format type. The content of the separate chapters or titles can include, among other things, video, audio, still or photographic pictures, or hypertext.

FIG. 2 shows a flow chart depicting the steps for accessing any encrypted digital content stored on the local storage medium 110. Typically, at least some digital content can be stored unencrypted on the local storage medium 110 and distributed to a user for immediate access to at least one chapter or title for a given price (step 205). If the user desires to access another separate chapter or title, or the rest of the encrypted digital content stored on the local storage medium 110, the user must request and get access, e.g., by paying to unlock the additional desired digital content. To access encrypted digital content stored on the local storage medium 110, the local digital content reader 105 transmits a request signal 125 through the transmission medium 115 to the remote digital content enabler 130 (step 210). The request signal contains information requesting access to specific digital content stored on the local storage medium 110 and can also include payment information. The request can be for one or more digital contents stored on the local storage medium 110.

In one embodiment, the payment information can be, for example, a credit card number, a debit card number, or a pre-paid debit card number. The payment information can be stored on the local digital content reader 105, the local digital content enabler 130, or both. The payment information can either be processed immediately or can accumulate on the local digital content reader 105 and processed periodically.

In another embodiment the payment information can be via a point system. A user can accumulate points either by purchase or by free promotion. Payment for points can be via monthly billing or instant credit card charge. The points can be stored either internally or through an external storage medium. The points can be stored internally using a SRAM with lithium battery, internal flash memory, or any other memory device known in the art. The points can be stored externally using a smart card, smart media, compact flash, or in an account on the remote digital content enabler 130 or other remote server. Each time a user views digital content stored on the local storage medium 110, an amount of points can be deducted from the total number of points of the user.

After the request signal 125 is received at the remote digital content reader 130, it processes the request signal 125 and transmits an enabler signal 120 through the transmission medium 115 back to the local digital content reader 105 (step 215). The local digital content reader 105 uses the enabler signal 120 to unlock the requested digital content. The local digital content reader 105 can now read the desired digital content stored on the local storage medium 110 as shown in step 220. The local digital content reader 105 can also store information regarding which digital content in the local storage medium 110 is enabled or disabled. The system for distributing digital content 100 provides an advantage by both protecting content stored on the local storage medium 110 and allowing for content access on demand.

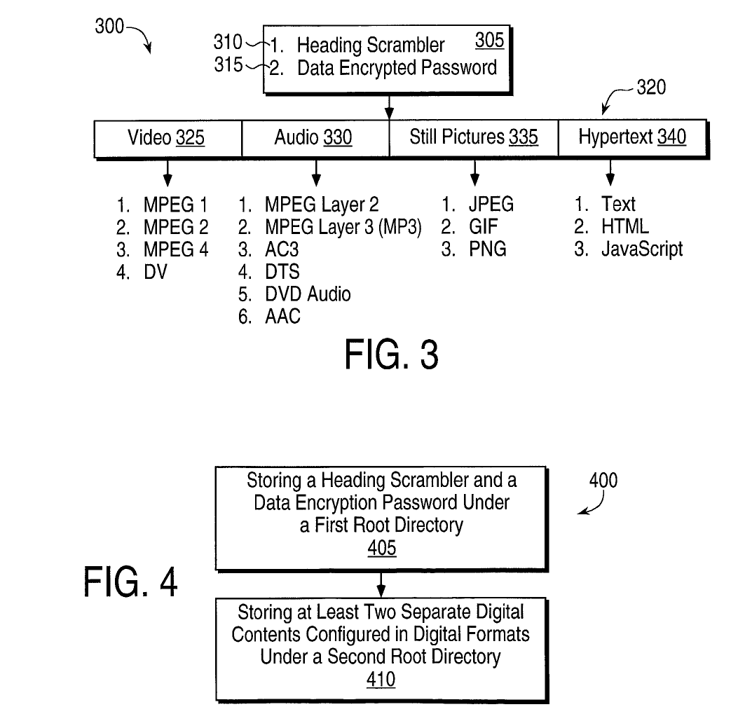

FIG. 3 shows one example of a format 300 for storing digital content on the local storage medium 110. The format 300 for storing digital content 300 on the local storage medium 110 includes a first root directory 305 and at least a second root directory 320. The first root directory includes a heading scrambler 310 and a data encrypted password 315. The second root directory is divided into multiple subdirectories, each subdirectory representing a different type of content. Typically, there will be at least two different files stored on local storage medium 110, one freely readable, and the other encrypted for future access. The different content types can include, among other things, video 325, audio 330, still or photographic pictures 335, and hypertext 340. Each file stored under the subdirectories can contain separate chapters or titles of digital content configured under different digital formats. Examples of digital formats under the video 325 subdirectory can be, e.g., MPEG1, MPEG2, MPEG4, or Digital Video (DV). Examples of digital formats under the audio 330 subdirectory can be, e.g., MPEG Layer 2, MPEG Layer 3 (MP3), AC3, DTS, DVD audio, or AAC. Examples of digital formats under the still pictures 335 subdirectory can be, e.g., JPEG, GIF, or PNG. Examples of digital formats under the hypertext 340 subdirectory can be, e.g., ordinary text files, HTML, or Javascript.

In another embodiment, multiple formats can be combined together to generate new content types. For example, MPEG1 or MPEG2, MPEG Layer 2 or MP3, and text are all combined to generate karaoke content. In another example, MPEG1 is combined with MPEG Layer 2 to generate video compact disc (VCD) content. Super video compact disc (SVCD) content can include MPEG2 and MPEG Layer 2. MPEG2 and AC3 or DTS can be combined to generate DVD content. Note that the list of content types given here is not exhaustive, and different formats can be combined to generate other content amalgamations.

FIG. 4 is a flow chart showing the steps for storing multiple digital contents on a local storage medium 110 according to the present invention. A heading scrambler 310 and a data encrypted password 315 are first stored under the first root directory 305 (step 405). Next, at least two separate digital contents possibly configured in different digital formats are stored under the second root directory 320 (step 410). For example, the digital content stored under the video subdirectory 325 could be divided into two separate chapters or titles. The first chapter may be configured in, e.g., an MPEG1 format and the second chapter may be configured in, e.g., an MPEG2 format, or other video formats. Or they can be configured in the same format.

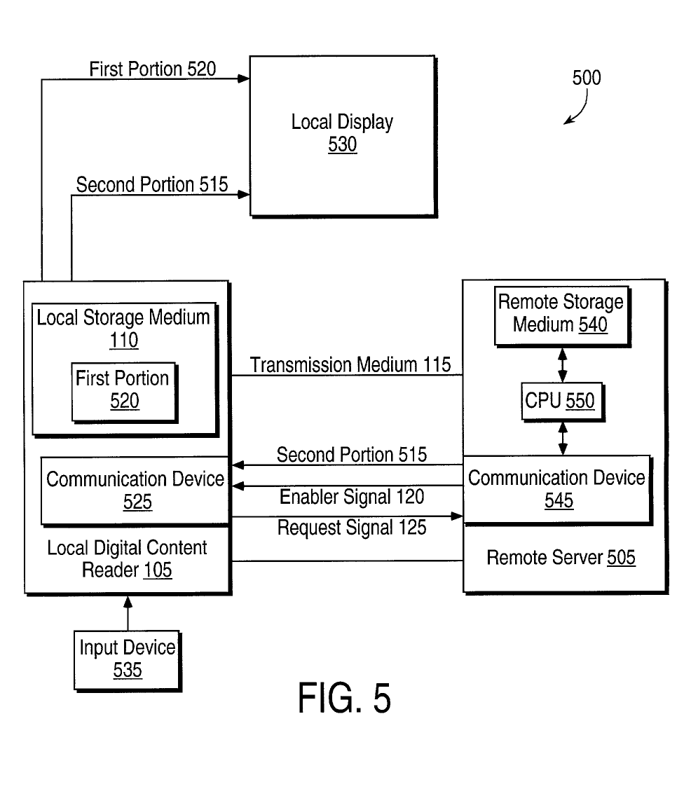

FIG. 5 shows one example of a system 500 for simultaneously displaying internet digital content from a remote server 505 and a local storage medium 110 on a local display 530. System 500 includes a local digital content reader 105, a local storage medium 110, a communication device 525, an input device 535, a transmission medium 115, a remote server 505, and a local display 530. The remote server includes a central processing unit (CPU) 545 electrically connected to a remote storage medium 540, and a communication device 545. The local storage medium 110 contains a first portion of the digital content 520 and is electrically connected to the local digital content reader 105. The communication device 525 can access the internet digital content stored in the remote storage medium 540 of the remote server 505 through the transmission medium 115.

The transmission medium 115 as before can be, among other things, a telephone line, wireless communication device, or a common network interface. The network interface can be any one of a number of network systems, including, e.g., a telephone system, a cellular network system, a local area network (LAN) system, or the Internet, for exchanging and transferring information. Other transmission mediums 115 may be used to access the internet digital content. The local display 530 can be a television, computer monitor, or any other type of display in which one can view digital content. The input device 535, for example, can be a keyboard, a wireless keyboard, a remote control, or other type of input device 535 well known in the art.

The local storage medium 110, for example, can be an optically-encoded disk including, e.g., a CD or DVD disk. In one embodiment, the digital content is stored and encrypted on the local storage medium 110 in a single digital format and divided into multiple separate chapters or titles. In another embodiment the digital content is stored and encrypted on the local storage medium 110 in multiple digital formats and divided into multiple separate chapters or titles within each format type. The storage formats can be substantially the same as that described above with reference to FIGS. 3 and 4.

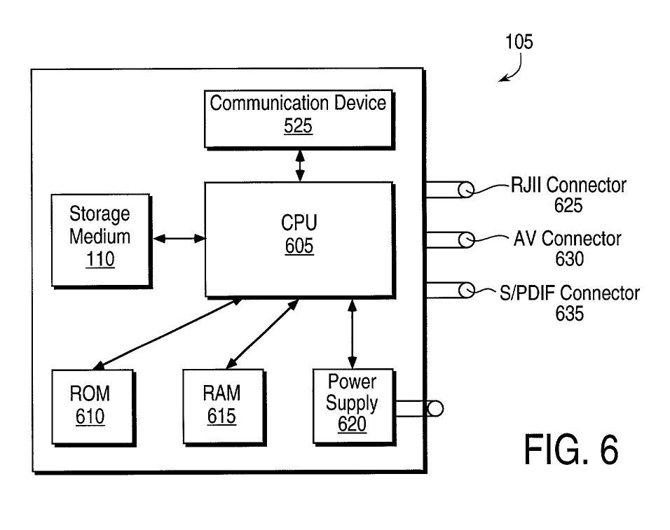

FIG. 6 shows a detailed drawing of one embodiment of the local digital content reader 105. The local digital content reader 105 includes a central processor unit (CPU) 605, a local storage medium 110, a communication device 525, read only memory (ROM) 610, random access memory (RAM) 615, and a power supply 620.

The local digital content reader 105 also includes multiple ports. The multiple ports can include an RJ11 connector 625, an AV connector 630, and a S/PDIF connector 635. In another embodiment (not shown) the local digital content reader 105 may also include a smart card reader, a video/audio decoder, flash memory, and an S-Video connector.

The CPU 605 is electrically connected to the storage medium 110, the ROM 610, the RAM 615, the communication device 525, and the power supply 620. The CPU generally performs all the web browsing and control functions for the local digital content reader 105. The CPU can also perform video/audio decoding or separate decoding circuits can be included. The ROM 610 and the RAM 615 can store software code and data. The communication device 525 can be a modem or other connection device which accesses the internet digital content through the transmission medium 115. Finally, the local storage medium 110 can be, e.g., a CD, a CD ROM drive, or a DVD drive.

The ports of the local digital content reader 105 can be used to connect the local digital content reader 105 to the local display 530 and/or the remote server 505. The AV connector 630 allows the local digital content reader 105 to upload video and audio signals to the local display 530. The local digital content reader may also include S/PDIF connectors and/or S-Video connectors. The S/PDIF connectors and S-Video connectors are also used to transmit video and audio signal to the local display 530. If the communication device 525 is a modem, the local digital content reader 105 can include an RJ11 port to connect to the remote server 505 through a telephone line. The power supply 620 provides power to the local digital content reader 105.

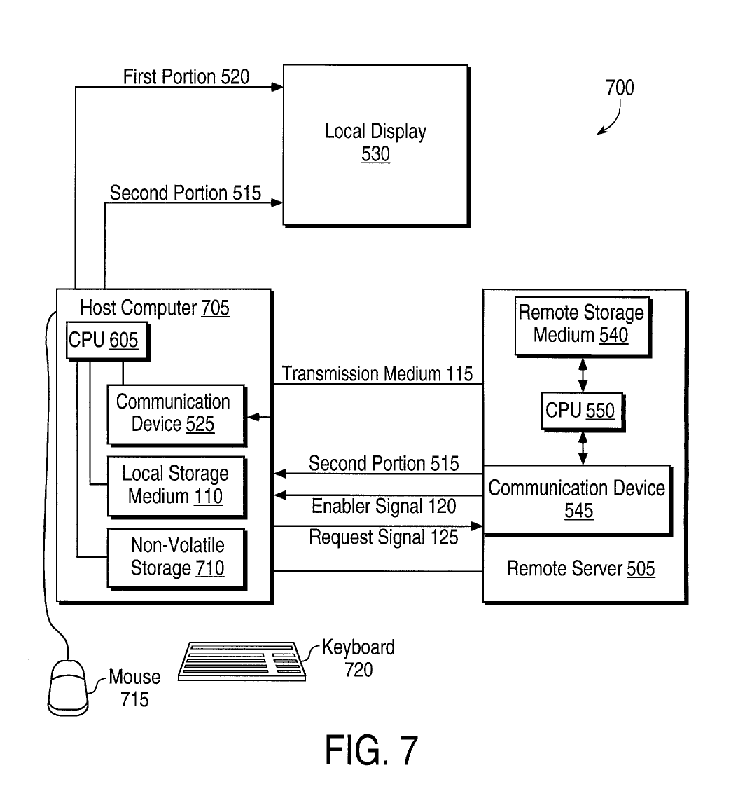

FIG. 7 shows another example of a system for simultaneously displaying internet digital content from a remote server 505 and a local storage medium 110 on a local display 530. In FIG. 7, the host computer 705 can replace the local digital content reader 105 shown in FIG. 5. The host computer 705 includes CPU 605 for receiving and processing digital content. CPU 605 is connected to non-volatile storage 710, such as RAM, dynamic read only memory (DRAM), static read only memory (SRAM), and other types of memory devices, which may store one or more software applications that may be loaded into the storage medium 110 and executed by the CPU 605. The host computer 705 can also include a communication device 525, such as a modem, which can connect via a transmission medium 115 to the internet digital content stored in the remote storage medium 540 of the remote server 505. The transmission medium 115 can be a telephone line, wireless communication device, or a common network interface. The network interface can be any one of a number of network systems including a telephone system, a cellular network system, a local area network (LAN) system, or the Internet for exchanging and transferring information. The host computer 705 can be operated by a user via mouse 715 manipulating a cursor (not shown) and a keyboard 720 for inputting data. All other functionality for the system for simultaneously displaying internet digital content from remote server 505 in FIG. 7 can be generally the same as described in FIG. 5 above.

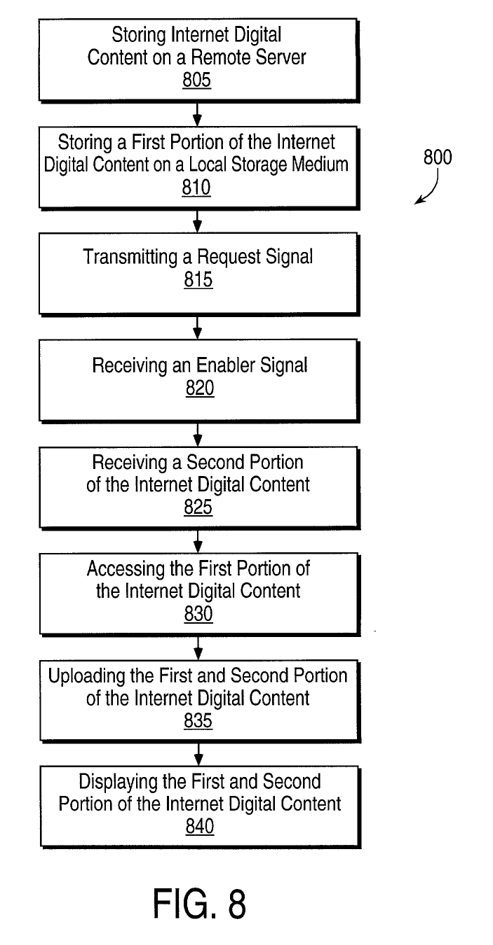

FIG. 8 shows a flow chart depicting a method for simultaneously displaying internet digital content from a remote server 505 and a local storage medium 110 on a local display 530. The internet digital content is first stored on the remote server 505 (step 805). A first portion of the internet digital content 520 is then stored on the local storage medium 110 and distributed to a user (step 810). Since the internet digital content can be frequently updated, a user may desire access to the updated internet digital content on the remote server 505. To obtain the updated internet digital content stored on the remote server 505, host computer 705 transmits a request signal 125 through the transmission medium 115 to the remote server 505 (step 815). The remote server 505 processes the request signal 125 and transmits an enabler signal 120 and a second portion of the internet digital content 515 to the host computer 705 (steps 820 and 825).

If the first portion of the internet digital content 520 located in the local storage medium 110 is encrypted, the enabler signal 120 allows the first portion of the internet digital content 520 to be unlocked by password, encryption key or similar technology. The host computer 705 then accesses the first portion of the internet digital content 520 (step 830). The host computer 705 then uploads both the first portion of the internet digital content 520 and the second portion of the internet digital content 515 to the local display 530 (step 835). Finally, the local display 530 displays the first portion of the internet digital content 520 and the second portion of the internet digital content 515 (step 840).

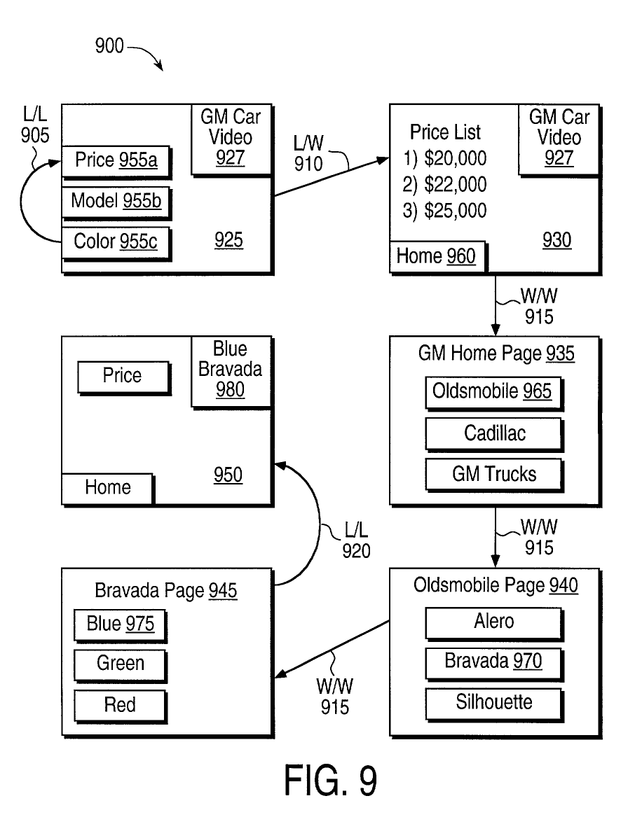

FIG. 9 illustrates the different types of links which can be achieved with system 500 for merging local and digital content 500, using consecutive local display 530 screen shots viewed on the local display 530. The different types of links include a local to local (L/L) link 905, a local to world (L/W) link 910, a world to world (W/W) link 915, and a world to local (W/L) link 920. A L/L link occurs when a user uploads digital content stored on the local storage medium 110 to the local display 530. For example, screen shot 925 shows a video clip 927 of a GM car uploaded from the local storage medium 110. The screen shot 925 also shows three icons uploaded from the local storage medium 110 which will provide information on different models, prices, and colors of GM cars. Each of the icons can have a URL link to a GM world wide web (web) page containing the appropriate up-to-date information. The advantage which a L/L link provides is that large streams of digital video or data may be quickly uploaded from the local storage medium 110 to the local display 530 rather than attempting to download the information to the local display 530 from the remote server 505. Digital content downloaded from the remote server 505 to the local display 530 can be low quality video, blocky, and take a relatively long time.

Another type of link is illustrated in the transition from screen shot 925 to screen shot 930. This second link is a local to world L/W link 910. For example, a user may desire to know the price information for the GM car shown in screen shot 925. To obtain this information, the user can click e.g., the “price” icon 955a uploaded from the local storage medium 110. The “price” icon 955a contains a URL link to the world wide web containing up-to-date price information. The GM car price information can be downloaded from the remote server 505 and displayed on the local display 530 along with the digital video clip 927 of the GM car which was previously uploaded to the local display 530 from the local storage medium 110 as shown in screen shot 930. Thus, screen shot 930 provides one example where local digital content (the GM car) and remote digital content (the up-to-date price information) are simultaneously merged onto the local display 530.

The transition from screen shot 930 to screen shot 935 demonstrates a third type of link, a World to World (W/W) link 915. For example, a user may want to link from the screen shot 930 downloaded from the GM website server to the GM car home page. The “home” icon 960 shown in screen shot 930 was remote digital content downloaded to the local display 530 from the remote server 530. A user may access the GM car home page on the Internet by depressing the “home” icon 960. Since the transition between screen shot 930 and screen shot 935 is from remote digital content on the web to other remote digital content on the web; a W/W link 915 is formed.

Another example of a W/W link 915 is shown in the transition between screen shot 935 and screen shot 940. A user can access remote digital content regarding Oldsmobiles by depressing the “Oldsmobile” icon 965 shown in screen shot 935. The remote digital content is then uploaded from the remote server 505 to the local display 530 as shown in screen shot 940. Yet another example of a W/W link 91.5 is illustrated in the transition from screen shot 940 to screen shot 945. If a user desires to see remote digital information regarding a specific kind of Oldsmobile, the user can depress the “Bravada” icon 970 shown in screen shot 940. Remote digital content regarding the Bravada will be uploaded to the local display 530 from the remote server 505.

The last type of link is illustrated in the transition from screen shot 945 to screen shot 950. This fourth link is a W/L link 920. For example, a user may desire to access a digital video clip of a blue Bravada that is actually stored on the local storage medium 110. To access the video clip of the blue Bravada, a user can depress the “blue” icon 975 shown on the web page in screen shot 945. A video clip 980 of a blue Bravada can then be uploaded from the local storage unit 110 to the local display 530 as shown in screen shot 950. This is another example where remote and digital content are merged and displayed on the local display 530.

The W/L link 920 provides a significant advantage by allowing a user to quickly upload and view large streams of digital content from the local storage medium 110 while surfing the Internet rather than downloading the digital content from a remote server 505. As discussed above, digital content downloaded from a remote server 505 to the local display 530 can suffer in both quality and download times due to bandwidth constraints. For example, a 32 Kbit modem has a transfer rate of 4000 bytes/sec over a telephone line. Even a 56 Kbit modem has a transfer rate of less than 7000 bytes/sec over a telephone line. In contrast, a CD drive can have a transfer rate of 170,000 bytes per second. Furthermore, a DVD drive, even at lower speeds can be four times as fast as a CD drive. A DVD drive can have a transfer rate of one megabyte per second or greater. Therefore, uploading digital content to a local display from a local storage medium, under control of a remote web page, overcomes the bandwidth problems associated with downloading digital content from a remote server 505.

Although the present invention has been described in detail, it should be understood that various changes, substitutions and alterations can be made hereto without departing from the spirit and scope of the invention as described by the appended claims. For example, a number of different apparatus can be used for a local digital content reader, a local storage medium, a remote digital content enabler; and for transmission media coupling the devices. Furthermore, the local display could be a computer or television screen.

What is claimed is:

1. A system for distributing digital content, comprising:
a local storage medium configured to store at least two separate digital contents;
a local digital content reader configured to read the digital contents stored on the local storage medium and to upload the digital content to a local display screen;
a remote digital content enabler configured to enable access to the digital contents stored on the local storage medium; and
a transmission medium, the local digital content reader configured to transmit a request signal through the transmission medium to the digital content enabler to request access to at least one of the digital contents and the remote digital content enabler configured to transmit an enabler signal through the transmission medium to the local digital content reader to enable the local digital content reader to read at least one of the digital contents.

2. The system of claim 1, wherein the remote server stores digital content.

3. The system of claim 1, wherein the digital content stored on the local storage medium and the remote server can be displayed on a local display.

4. The system of claim 1, wherein the local storage medium comprises:
at least one file for protecting the contents of the local storage medium; and
a plurality of content directories, the content directories having at least two files, the files containing separate digital content configured under a respectively different digital format.

5. The system of claim 4, wherein the content directories can include any of video, audio, photographic, or hypertext content.

6. The system of claim 4, wherein the video content can be encoded in any of MPEG1, MPEG2, MPEG4, or Digital Video formats.

7. The system of claim 4, wherein the audio content can be encoded in any of MPEG Layer 2, MPEG Layer 3, AC3, DTS, DVD audio, or AAC formats.

8. The system of claim 4, wherein the photographic content can be encoded in any of JPEG, GIF, or PNG formats.

9. The system of claim 4, wherein the hypertext content can be any of text, HTML, or Javascript formats.

10. The system of claim 1, wherein the digital content on the local storage medium is encrypted.

11. The system of claim 10, wherein the local digital content reader decrypts the encrypted digital content stored on the local storage medium upon receipt of the enabler signal.

12. The system of claim 1, wherein the digital content on the local storage medium contains payment information.

13. The system of claim 1, wherein the request signal contains information requesting specific digital content.

14. The system of claim 12, wherein the payment information can comprise any of a credit card number, debit card number, or a pre-paid debit card number.

15. The system of claim 12, wherein the payment information can comprise accumulated credit.

16. The system of claim 15, wherein the accumulated credit has been purchased with any of a credit card number, debit card number, or pre-paid debit card number.

17. The system of claim 16, wherein the accumulated credit has been accumulated without requiring payment.

18. A method for distributing digital content, comprising the steps of:
storing at least two separate digital contents on a local storage medium;
transmitting a request signal from a local digital content reader to a remote digital content enabler over a transmission medium to request access to at least one of the digital contents;
receiving an enabler signal at the local digital content reader from the remote digital content enabler over the transmission medium to enable the local digital content reader to access at least one of the digital contents stored on the local storage medium; and
reading at least one of the digital contents stored on the local storage medium.

19. The method of claim 18, further comprising the steps of:
encrypting the digital content stored on the local storage medium;
storing the digital content on the local storage medium;
paying for access to the digital content on the local storage medium using a credit card, a debit card, or a pre-paid debit card over the transmission medium; and
paying for access to the digital content using accumulated credit purchased at an earlier time with the credit card, the debit card, or the pre-paid debit card.

20. The method of claim 18, wherein the remote server stores digital content.

21. The method of claim 18, wherein the digital content stored on the local storage medium and the remote server can be displayed on a local display.

22. The method of claim 18, wherein the local storage medium comprises:
at least one file for protecting the contents of the local storage medium; and
a plurality of content directories, the content directories having at least two files, the files containing separate digital content configured under a respectively different digital format.

23. The method of claim 22, wherein the content directories can include any of video, audio, photographic, or hypertext content.

24. The method of claim 23, wherein the video content can be encoded in any of MPEG1, MPEG2, MPEG4, or Digital Video formats.

25. The method of claim 23, wherein the audio content can be encoded in any of MPEG Layer 2, MPEG Layer 3, AC3, DTS, DVD audio, or AAC formats.

26. The method of claim 23, wherein the photographic content can be encoded in any of JPEG, GIF, or PNG formats.

27. The method of claim 23, wherein the hypertext content can be any of text, HTML, or Javascript formats.

28. The method of claim 19, wherein the local digital content reader decrypts the encrypted digital content stored on the local storage medium upon receipt of the enabler signal.

29. A system for displaying digital content from a remote server and a local storage medium, comprising:
a local storage medium configured to store a first portion of the digital content;
a local digital content reader configured to read the first portion of the digital content stored on the local storage medium;
a remote server configured to store digital content and for enabling access to the first portion of the digital content stored on the local storage medium;
a transmission medium, the local digital content reader configured to transmit a request signal from the local digital content reader to the remote server requesting access to a second portion of the digital content, the remote server configured to transmit an enabler signal from the remote server to the local digital content reader to enable the first portion of the digital content stored on the local storage medium, and the remote server configured to transmit the second portion of the digital content to the local digital content reader;
an input device for inputting data to the local digital content reader; and
a local display for displaying both the first and second portions of the digital content.

30. The system of claim 29, wherein the local digital content reader comprises:
a communication device for accessing the instant digital content stored in the remote server through the transmission medium;
a random access memory;
a read only memory;
at least one input or output port;
a power supply; and
the local storage medium for storing local digital content.

31. The system of claim 30, wherein the ports can be an RJ11 connector, an AV connector, a S/PDIF connector, and/or an S-Video connector.

32. The system of claim 29, wherein the local storage medium comprises:
at least one file for protecting the contents of the local storage medium; and
a plurality of content directories, the content directories having at least two files, the files containing separate digital content configured under a respectively different digital format.

33. The system of claim 32, wherein the content directories can include any of video, audio, photographic, or hypertext content.

34. The system of claim 33, wherein the video content can be encoded in any of MPEG1, MPEG2, MPEG4, or Digital Video formats.

35. The system of claim 33, wherein the audio content can be encoded in any of MPEG Layer 2, MPEG Layer 3, AC3, DTS, DVD audio, or AAC formats.

36. The system of claim 33, wherein the photographic content can be encoded in any of JPEG, GIF, or PNG formats.

37. The system of claim 33, wherein the hypertext content can be any of text, HTML, or Javascript formats.

38. The system of claim 29, wherein the digital content on the local storage medium is encrypted.

39. The system of claim 38, wherein the local digital content reader decrypts the encrypted digital content stored on the local storage medium upon receipt of the enabler signal.

40. The system of claim 29, wherein the request signal contains information requesting specific digital content.

41. The system of claim 29, wherein the digital content on the local storage medium contains payment information.

42. The system of claim 41, wherein the payment information can comprise accumulated credit.

43. The system of claim 41, wherein the payment information is a credit card number, debit cart number, or a pre-paid debit card number.

44. The system of claim 42, wherein the payment information can be accumulated credit which has been purchased with the credit card number, the debit card number, or the pre-paid debit card number.

45. The system of claim 29, wherein the first portion of the digital content together with the second portion of the digital content comprise the digital content.

46. The system of claim 29, wherein the first portion of the digital content together with the second portion of the digital content comprise a portion of the digital content.

47. The system of claim 29, wherein the local digital content reader can be a host computer, the host computer comprising:
a central processor unit;
a non-volatile storage;
a communication device for accessing the digital content stored in the remote server through the transmission medium; and
the local storage medium for storing local digital content.

48. A method for displaying digital content from a remote server and a local storage medium, comprising the steps of:
storing a first portion of the digital content on a local storage medium;
storing a second portion of the digital content on a remote server;
transmitting a request signal from a local digital content reader to the remote server over a transmission medium;
receiving an enabler signal and the second portion of the digital content at the local digital content reader from the remote server over the transmission medium;
using the enabler signal to access the first portion of the digital content stored on the local storage medium;
uploading the first and second portion of the digital content from the local digital content reader to a local display; and
displaying the first and second portion of the digital content on the display.

49. The method of claim 48, further comprising the steps of:
encrypting the first portion of digital content stored on the local storage medium; and
paying for access to the digital content on the local storage medium using a credit card, a debit card, a pre-paid debit card, or accumulated credit over the transmission medium, to cause the remote server to transmit the enabler signal.

50. The method of claim 48, wherein the local storage medium comprises:
at least one file for protecting the contents of the local storage medium; and
a plurality of content directories, the content directories having at least two files, the files containing separate digital content configured under a respectively different digital format.

51. The method of claim 50, wherein the content directories can include any of video, audio, photographic, or hypertext content.

52. The method of claim 51, wherein the video content can be encoded in any of MPEG1, MPEG2, MPEG4, or Digital Video formats.

53. The method of claim 51, wherein the audio content can be encoded in any of MPEG Layer 2, MPEG Layer 3, AC3, DTS, DVD audio, or AAC formats.

54. The method of claim 51, wherein the photographic content can be encoded in any of JPEG, GIF, or PNG formats.

55. The method of claim 51, wherein the hypertext content can be any of text, HTML, or Javascript formats.

56. The method of claim 49, wherein the local digital content reader decrypts the encrypted digital content stored on the local storage medium in response to the enable signal.

57. The method of claim 48, wherein the first portion of the digital content together with the second portion of the digital content make up a portion of the digital content.

58. A local digital content reader, comprising:
a local storage medium configured to store a first portion of a digital content;
a communication device configured to transmit a request signal from the local digital content reader to a remote server over a transmission medium and to receive an enabler signal and a second portion of the digital content from the remote server over the transmission medium; and
a central processing unit configured to receive the enabler signal and, upon receipt, to access the first portion of the digital content stored on the local storage medium and to then upload the first and second portions of the digital content to a local display.

59. The method of claim 58, wherein the local digital content reader is further configured to encrypt the first portion of digital content stored on the local storage medium.

60. The method of claim 58, wherein the local storage medium comprises:
at least one file for protecting the contents of the local storage medium; and
a plurality of content directories, the content directories having at least two files, the files containing separate digital content configured under a respectively different digital format.

61. The method of claim 60, wherein the content directories can include any of video, audio, photographic, or hypertext content.

62. The method of claim 61, wherein the video content can be encoded in any of MPEG1, MPEG2, MPEG4, or Digital Video formats.

63. The method of claim 61, wherein the audio content can be encoded in any of MPEG Layer 2, MPEG Layer 3, AC3, DTS, DVD audio, or AAC formats.

64. The method of claim 61, wherein the photographic content can be encoded in any of JPEG, GIF, or PNG formats.

65. The method of claim 61, wherein the hypertext content can be any of text, HTML, or Javascript formats.

66. The method of claim 59, wherein the local digital content reader decrypts the encrypted digital content stored on the local storage medium in response to the enabler signal.

67. The method of claim 58, wherein the first portion of the digital content together with the second portion of the digital content make up a portion of the digital content.

68. A remote server, comprising:
a remote storage medium configured to store digital content;
a communication device configured to:
receive a request signal from a local digital content reader over a transmission medium;
transmit an enabler signal to a local digital content reader over the transmission medium to access a first portion of the digital content stored on a local storage medium;
transmit a second portion of the local digital content stored on the remote storage medium to the local digital content reader over the transmission medium; and
a central processing unit configured to access the second portion of digital content from the remote storage medium.

69. The remote server of claim 68, wherein the remote server reads payment information within the request signal causing the remote server to transmit the enabler signal to the local digital content reader.

70. The remote server of claim 68, wherein the payment information can be in the form of credit card number, a debit card number, a pre-paid debit card number, or accumulated credit.

71. The method of claim 69, wherein the enabler signal decrypts the encrypted digital content stored on the local storage medium.

72. The method of claim 68, wherein the first portion of the digital content together with the second portion of the digital content make up a portion of the digital content.
